(19) United States
(12) Patent Application Publication
(10) Pub. No.: US 2017/0214761 A1
(43) Pub. Date: Jul. 27, 2017

(54) Method and Wireless Communication System for Processing Data

(71) Applicants: National Taiwan University, Taipei City (TW); MEDIATEK INC., Hsin-Chu (TW)

(72) Inventors: Hsiang Hsu, Kaohsiung City (TW); Kwang-Cheng Chen, Taipei City (TW)

(21) Appl. No.: 15/002,410

(22) Filed: Jan. 21, 2016

(51) Int. Cl. H04L 29/08; H04W 28/02; H04W 28/06; H04W 24/08

(52) U.S. Cl. CPC H04L 67/2842; H04W 24/08; H04W 28/0231; H04W 28/0289; H04W 28/06

(57) ABSTRACT

A method is to process packets in a wireless communication system including an evolved core network, a plurality of user devices, and an evolved node B (eNB), the evolved core network including a policy and charging rules function (PCRF), a serving gateway, a caching management gateway and a mobile management entity (MME). The method includes receiving, via the PCRF, the packets; obtaining, via the MME, an user device number; estimating, via the caching management gateway, a connectivity parameter corresponding to the user devices; generating, via the caching management gateway, a decision result according to popularities and sizes of the packets, the user device number and the connectivity parameter; and instructing, via the serving gateway, the eNB and the user devices to cache the packets according to the decision result.

### BACKGROUND OF THE INVENTION

1. Field of the Invention

The present invention relates to a method and a wireless communication system for processing data, and more particularly, to a method and a wireless communication system which adaptively monitor and cache data according to data popularities and sizes for reducing data request latency.

2. Description of the Prior Art

Internet traffic dominates the wireless mobile data transmission volume and is expected to increase dramatically. The growing data demand is primarily created by smart phones, notebooks and tablet users with numerous applications, particularly the major role of social media in Internet content transportation. Under such circumstances, mobile telecommunication operators and designers have to increase cellular network capacity and backhaul bandwidth. As spectral usage for Long Term. Evolution (LTE) standard is approaching the Shannon limit, the promising solution widely embraced by operators is deploying small cells, establishing a more complex structure of heterogeneous multi-layers cellular networks.

Implementing techniques such as Multiple Input Multiple Output (MIMO) as well as massive MIMO are other possible solutions by serving users with numerous antennas simultaneously using the same frequency resources. Since these solutions result in growing inter-cell interference levels, even more controlling signals, like channel state information, interference alignment, power control, etc., have to be imposed in present LTE systems, where nearly half of wireless bandwidth is occupied by control signals. Furthermore, when Internet traffic dominates in mobile networks, quality of experience (QoE), particularly latency, might be more important than quality of service (QoS), which again suggests a new approach to redesign the conventional wireless communication system.

In addition to lack of radio spectrum, the insufficiency of backhaul network bandwidth and the slow response time of the data centers/servers remain to be a bottleneck for low latency requirements. Under present cellular network architectures, if the request of data from an user device is accepted, the data will have to be retrieved from data centers/servers, and then the routed through packet data gateway (P-GW), the serving gateway (S-GW), the base station (e.g. eNodeB, eNB in LTE), and finally to the user device. Most of the response time to users is consumed by the time for demanding data from data servers. The backhaul resources optimization merges as another dimension of resource allocation in the conventional wireless communication system.

Therefore, it has become an important issue to provide an efficient method and wireless communication system for adaptively processing data for reducing data request latency in the wireless communication system.

### SUMMARY OF THE INVENTION

Therefore, the primary objective of the present invention is to provide a method and a wireless communication system which adaptively monitor and cache data according to data popularities and sizes for reducing data request latency.

The present invention discloses a method of processing packets in a wireless communication system comprising an evolved core network, a plurality of user devices, and an evolved node B (eNB), the evolved core network comprising a policy and charging rules function (PCRF), a serving gateway, a caching management gateway and a mobile management entity (MME). The method comprises receiving, via the PCRF, the packets; obtaining, via the MME, an user device number; estimating, via the caching management gateway, a connectivity parameter corresponding to the user devices; generating, via the caching management gateway, a decision result according to popularities and sizes of the packets, the user device number and the connectivity parameter; and instructing, via the serving gateway, the eNB and the user devices to cache the packets according to the decision result.

The present invention further discloses a wireless communication system comprises a plurality of user devices; an evolved node B (eNB), coupled to the plurality of user devices; and an evolved core network, coupled to the eNB, comprising a policy and charging rules function (PCRF), a serving gateway, a caching management gateway and a mobile management entity (MME), wherein the PCRF receives the packets, the MME obtains an user device number, the caching management gateway estimates a connectivity parameter corresponding to the user devices and generates a decision result according to popularities and sizes of the packets, the user device number and the connectivity parameter, and the serving gateway instructs the eNB and the user devices to cache the packets according to the decision result.

The present invention further discloses a method of processing packets in a wireless communication system comprising an evolved core network, a plurality of user devices, and an evolved node B (eNB), the evolved core network comprising a caching management gateway and a mobile management entity (MME). The method comprises sending, via one of the user devices, a request to the eNB; decrypting, via the eNB, the request; and retrieving, via the one of the user devices, the packets from the eNB or from the other user devices according to a decision result; wherein the decision result is generated by the caching management gateway according to popularities and sizes of the packets, a user device number and a connectivity parameter, the user device number is obtained via the MME, and the connectivity parameter is estimated by the caching management gateway.

The present invention further discloses a wireless communication system comprises a plurality of user devices; an evolved node B (eNB), coupled to the plurality of user devices; and an evolved core network, coupled to the eNB, comprising a caching management gateway and a mobile management entity (MME), wherein one of the user devices sends a request to the eNB, the eNB decrypts the request, the one of the user devices retrieves the packets corresponding to the request from the eNB or from the other user devices according to a decision result, the decision result is generated by the caching management gateway according popularities and sizes of the packets, an user device number and a connectivity parameter, the user device number is obtained via the MME, and the connectivity parameter is estimated by the caching management gateway.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a wireless communication system according to an embodiment of the invention.

FIG. 2 illustrates a process for the wireless communication system shown in FIG. 1 to process packets according to an embodiment of the invention.

FIG. 3 illustrates a schematic diagram of a comparison between the average access time and the storage capacity according to an embodiment of the invention.

FIG. 4 illustrates another process for the wireless communication system shown in FIG. 1 to process packets according to an embodiment of the invention.

### DETAILED DESCRIPTION

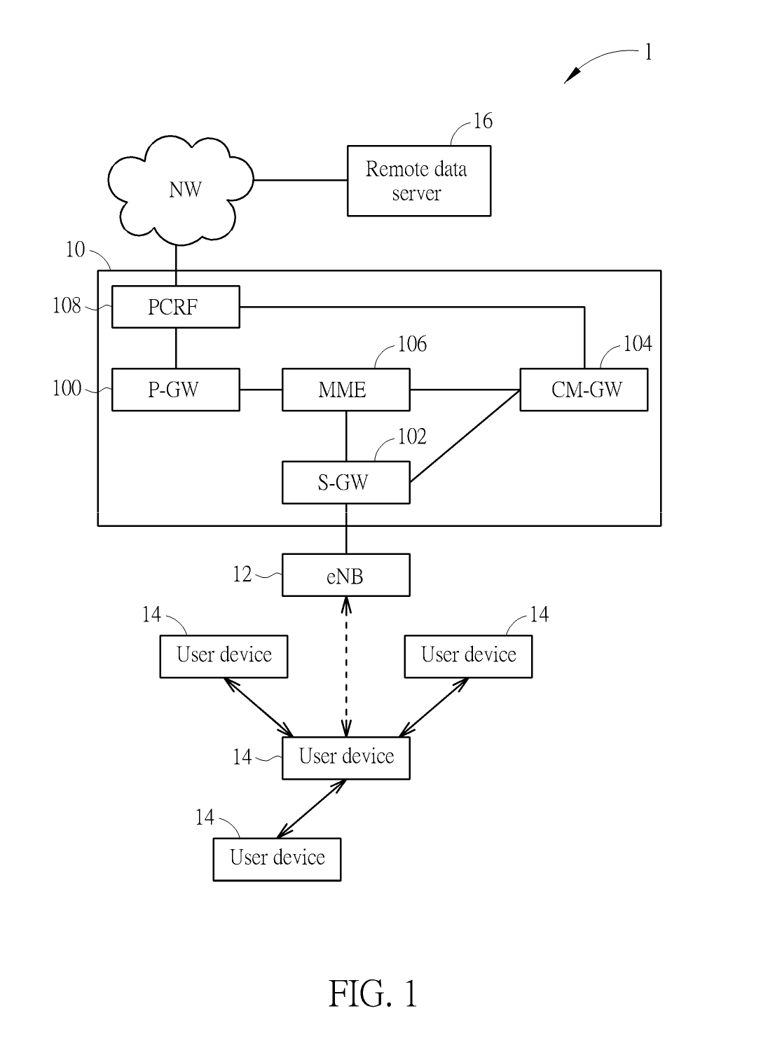

Please refer to FIG. 1, which illustrates a schematic diagram of a wireless communication system 1 according to an embodiment of the invention. The wireless communication system 1 comprises an evolved core network 10, an evolved node B (eNB) 12, a plurality of user devices 14, a network NW and a remote data server 16. The evolved core network 10 receives packets corresponding to at least one social media from the remote data server 16 via the network NW, and comprises a packet gateway (P-GW) 100, a serving gateway (S-GW) 102, a caching management gateway (CM-GW) 104, a mobile management entity (MME) 106 and a policy and charging rules function (PCRF) 108. In detail, the PCRF 108 is connected between the network NW and the P-GW 100, to receive and monitor the packets from the remote data server 16. The CM-GW 104 is coupled to the PCRF 108, the MME 106 and the S-GW 102. The S-GW 102 is coupled to the MME 106 and the P-GW 100. Accordingly, under operations of the evolved core network 10, the packets corresponding to the at least one social media are transferred from the evolved core network 10 to the eNB 12. Moreover, the eNB 12 is coupled between the S-GW 102 of the evolved core network 10 and the user devices 14, to bridge the user devices 14 to the remote data server 16 for receiving the packets corresponding to the at least one social media. Also, the user devices 14 may communicate to each other via a device-to-device (D2D) communication. Under such circumstances, the CM-GW 104 of the embodiment plays an important role to adaptively reallocate the received packets to be accessed and retrieved by any of the user devices 14. Detailed operations are described in the following paragraphs.

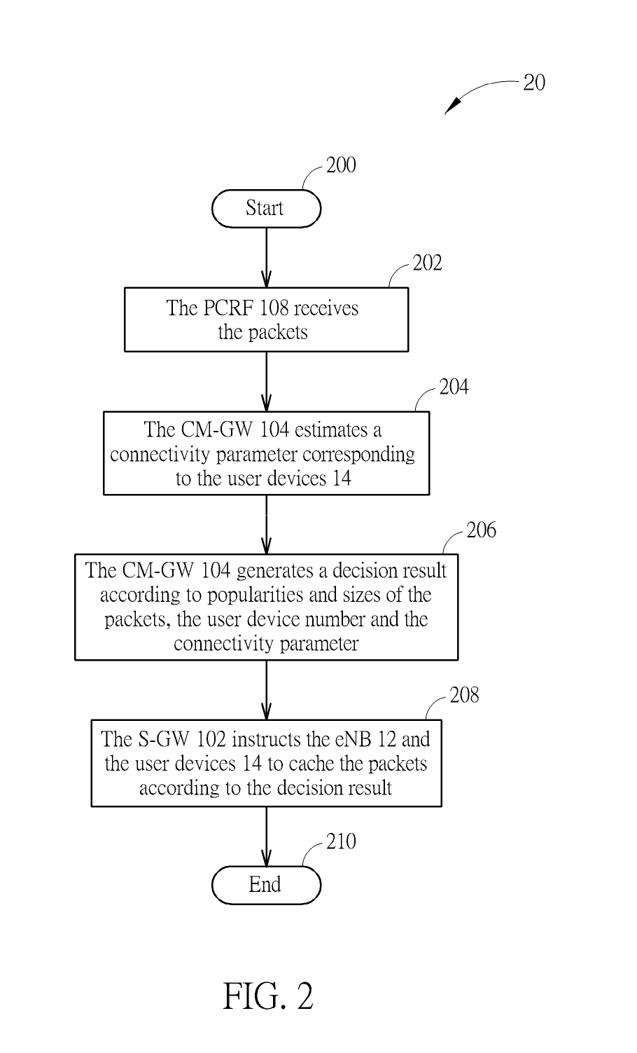

Please refer to FIG. 2, which illustrates a process 20 for the wireless communication system 1 shown in FIG. 1 to process packets according to an embodiment of the invention. The process 20 may be compiled into one or more programming codes to be stored in composition components of the wireless communication system 1, and comprises the following steps:

Step 200: Start.

Step 202: The PCRF 108 receives the packets.

Step 204: The CM-GW 104 estimates a connectivity parameter corresponding to the user devices 14.

Step 206: The CM-GW 104 generates a decision result according to popularities and sizes of the packets, the user device number and the connectivity parameter.

Step 208: The S-GW 102 instructs the eNB 12 and the user devices 14 to cache the packets according to the decision result.

Step 210: End.

In the process 20, the embodiment focuses on how to cache the received packets corresponding to the social media in the eNB 12 or in the user devices 14. Initially, in step 202, the PCRF 108 receives the packets corresponding to at least one social media from the remote data server 16 to obtain popularities and sizes of the packets corresponding to the social media. In addition, the eNB 12 monitors a current transmission condition corresponding to each user device 14, to obtain a total available bandwidth and a spectrum partition factor corresponding to each user device 14, so as to transmit the current transmission condition corresponding to each user device 14 in the form of vectors to the S-GW 102. The MME 106 determines an user device number according to registrations of the user devices 14.

Next, in step 204, a connectivity estimator in the CM-GW 104 generates a connectivity parameter according to the current transmission condition corresponding to each user device 14 and the user device number. Preferably, the connectivity parameter of the embodiment is a connectivity among the user devices 14 to be estimated by a minimum variance unbiased estimator (MVUE), which is not limiting the scope of the invention.

In step 206, the CM-GW 104 generates a decision result according to the popularities and sizes of the packets corresponding to the social media from the PCRF 108, the user device number from the MME 106 and the connectivity parameter from the connectivity estimator, and accordingly, the decision result is transmitted from the CM-GW 104 to the S-GW 102 for following caching operations. Additionally, the decision result of the embodiment may be periodically updated due to updating/changing of the popularities and sizes of the packets corresponding to the social media, the user device number and the connectivity parameter, which is not limiting the scope of the invention.

Finally, in step 208, the S-GW 102 instructs the eNB 12 and the user devices 14 to cache the packets according to the decision result. In other words, the decision result of the embodiment may be applied to the packets corresponding to the social media, which have just been inputted in the evolved core network 10, to determine whether the eNB 12 or the at least one of the user devices 14 is responsible for caching the packets corresponding to the social media. Preferably, once the decision result is determined by the CM-GW 104, the S-GW 102 broadcasts the decision result via a broadcast control channel to all the connected user devices 14, such that all the user devices 14 connected to the eNB 12 may understand where to request and retrieve the required packets via the D2D communication or the user devices 14 connected to the eNB 12 may directly retrieve the required packets from the eNB 12.

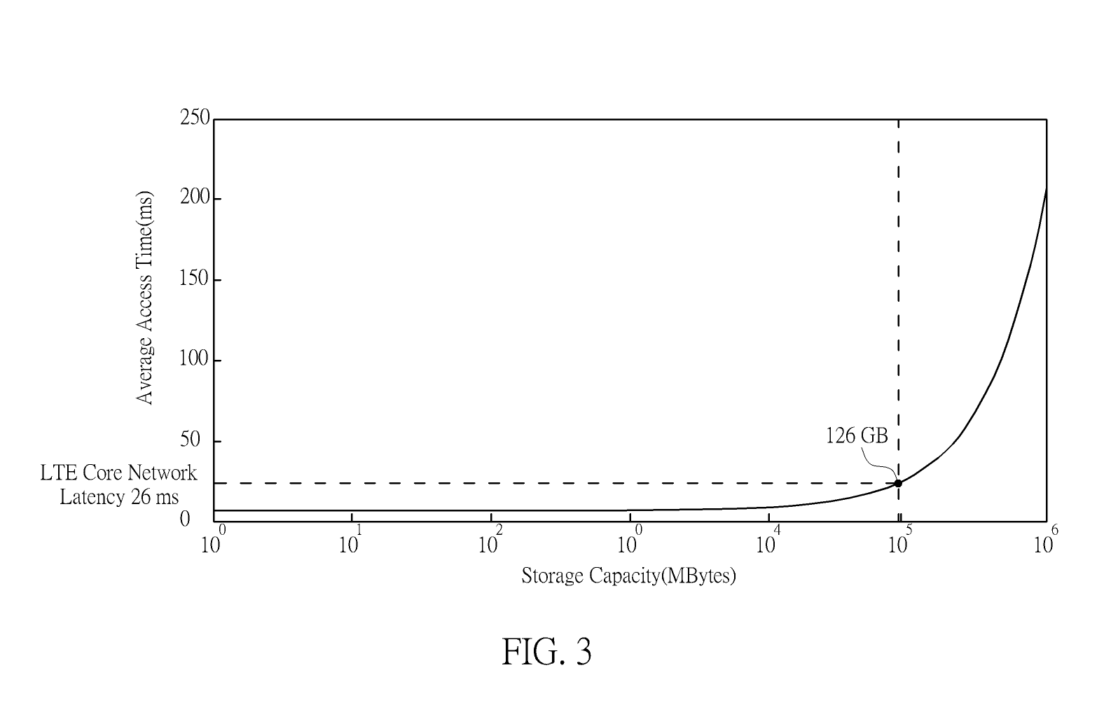

Noticeably, a storage capacity at the eNB 12 of the embodiment may be determined according to a latency of the evolved core network 10. When the packets corresponding to the social media are cached in one or more of the user devices 14, there is an average access time for the packets to be transmitted from one user device 14 to another user device 14 via the D2D communication. Furthermore, the evolved core network 10 of the embodiment has the latency (i.e. a signal transmission delay) for directly transmitting the packet from the remote data server 16 to the user device 14. Under such circumstances, there is a trade-off between the average access time and the latency of the evolved core network 10. For example, as shown in FIG. 3, if the evolved core network has the latency of 26 ms, the storage capacity at the eNB 12 of the embodiment may be predetermined as 126 GB, which is not limiting the scope of the invention.

In other words, the process 20 of the invention controls the wireless communication system 1 to adaptively allocate and cache the received packets corresponding to at least one social media, such that the CM-GW 104 of the evolved core network 10 is operated to generate the decision result for the received packets, so as to determine to cache the received packets in the eNB 12 or in one or multiple user devices 14. Accordingly, the packets corresponding to at least one social media may be adaptively cached inside the wireless communication system 1, and one user device 14 may directly access/obtain the cached packets from the eNB 12 or from the neighboring user device(s) 14 via the D2D communication, rather than retrieving from the remote data server 16, which can significantly save the burden of the wireless communication system 1 and avoid the latency.

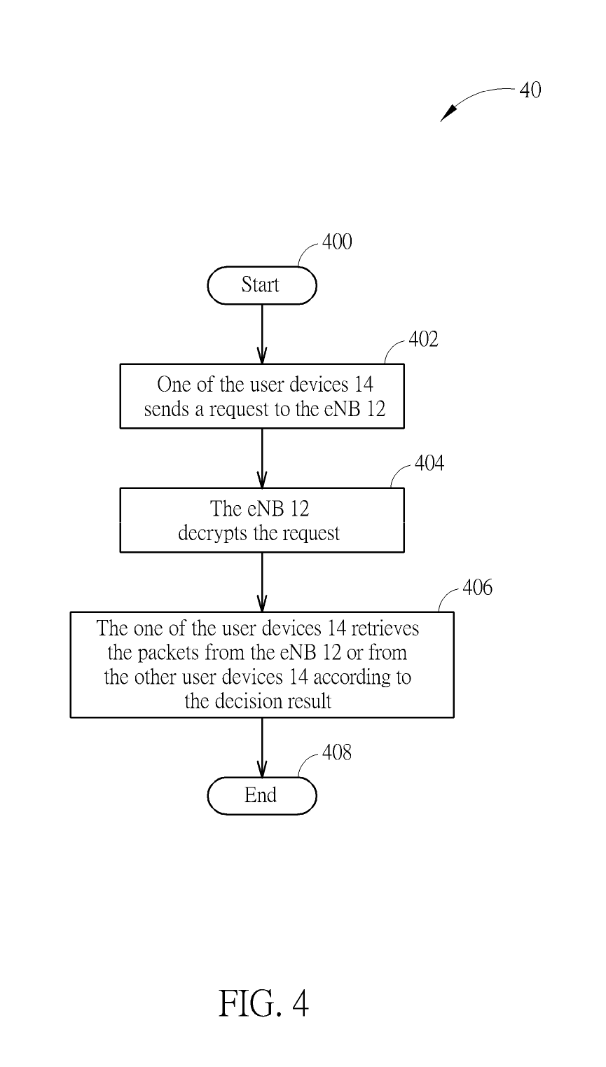

Please refer to FIG. 4, which illustrates a process 40 for the wireless communication system 1 shown in FIG. 1 to process packets according to an embodiment of the invention. The process 40 may be compiled into at least one or more programming codes to be stored in composition components of the wireless communication system 1, and comprises the following steps:

Step 400: Start.

Step 402: One of the user devices 14 sends a request to the eNB 12.

Step 404: The eNB 12 decrypts the request.

Step 406: The one of the user devices 14 retrieves the packets from the eNB 12 or from the other user devices 14 according to the decision result.

Step 408: End.

After the packets corresponding to the social media have been cached in the wireless communication system 1, the user device 14 may trigger a request for retrieving/accessing the cached packets corresponding to the social media according to the process 40. In step 402, one of the user devices 14 sends the request to the eNB 12. Preferably, the request of the embodiment is sent from the one of the user devices 14 to the eNB 12 via a physical uplink shared channel (PUSCH), which is not limiting the scope of the invention. Next, in step 404, the eNB 12 decrypts contents of the request (e.g. the uniform resource locator, URL) to know what kinds of packets are requested by the one of the user devices 14, such that the eNB 12 may find and prepare the requested packets via the decision result for the one of the user devices 14. Accordingly, in step 406, the one of the user devices 14 knows where to retrieve the cached packets via the instruction of the eNB 12 (i.e. the predetermined decision result inside the eNB 12), so as to obtain and access the cached packets from the eNB 12 or from the other user devices 14 via the D2D communication.

Noticeably, if the eNB 12 of the embodiment determines that the requested packet is not cached in the eNB 12 or in any one of the user devices 14, the P-GW 100 of the evolved core network 10 further routes the request to the remote data server 16, so as to retrieve the packets corresponding to the request from the remote data server 16 for the one of the user devices 14. In other words, considering different requirements or transmission conditions, the wireless communication system 1 may also be selectively operated to retrieve the packets not only from the eBN 12 and the D2D communication but also from the remote data server 16, such that more flexibility and efficiency can be achieved, which is also within the scope of the invention.

In other words, the embodiments of the invention inherit the well-known features from the LTE network and add the new caching and retrieving mechanism for the packets corresponding to at least one social media. In comparison with the prior art, the new caching and retrieving mechanisms for the packets of the embodiment are easily accessible and not expensive because caching the packets at infrastructure (e.g. direct accessing from the eNB) can alleviate the traffic burden and improves latency. Moreover, via the D2D communication, more cellular radio resource can be traded and saved to reduce the latency for each user device. Certainly, the new caching and retrieving mechanisms for the packets of the embodiment can also be applied to the cloud-radio access network (C-RAN) or other similar network architectures, which is also within the scope of the invention.

In summary, the embodiments of the invention provide a method and a wireless communication system for processing packets corresponding to at least one social media. By adaptively caching the received packets in the eNB or in one or many user devices, the user directly accesses and retrieves the requested packets from the connected eNB or from the neighboring user devices via the D2D communication, such that data request latency in the wireless communication system can be reduced to improve the transmission efficiency, and burden of the wireless communication system can also be reduced significantly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing packets in a wireless communication system comprising an evolved core network, a plurality of user devices, and an evolved node B (eNB), the evolved core network comprising a policy and charging rules function (PCRF), a serving gateway, a caching management gateway and a mobile management entity (MME), the method comprising:
receiving, via the PCRF, the packets;
obtaining, via the MME, an user device number;
estimating, via the caching management gateway, a connectivity parameter corresponding to the user devices;
generating, via the caching management gateway, a decision result according to popularities and sizes of the packets, the user device number and the connectivity parameter; and
instructing, via the serving gateway, the eNB and the user devices to cache the packets according to the decision result.

2. The method of claim 1, wherein the decision result is applied to the packets to determine whether the eNB or at least one of the user devices caches the packets, and the user devices share the cached packets via a device-to-device communication.

3. The method of claim 1, wherein the connectivity parameter is a connectivity among the user devices to be estimated by a minimum variance unbiased estimator (MVUE).

4. The method of claim 1, wherein a storage capacity at the eNB is determined according to a latency of the evolved core network.

5. The method of claim 1, wherein the popularities and the sizes of the packets are obtained via the PCRF.

6. A wireless communication system, comprising:
a plurality of user devices;
an evolved node B (eNB), coupled to the plurality of user devices; and
an evolved core network, coupled to the eNB, comprising a policy and charging rules function (PCRF), a serving gateway, a caching management gateway and a mobile management entity (MME);
wherein the PCRF receives the packets, the MME obtains an user device number, the caching management gateway estimates a connectivity parameter corresponding to the user devices and generates a decision result according to popularities and sizes of the packets, the user device number and the connectivity parameter, and the serving gateway instructs the eNB and the user devices to cache the packets according to the decision result.

7. The wireless communication system of claim 6, wherein the decision result is applied to the packets to determine whether the eNB or at least one of the user devices caches the packets, and the user devices share the cached packets via a device-to-device communication.

8. The wireless communication system of claim 6, wherein the connectivity parameter is a connectivity among the user devices to be estimated by a minimum variance unbiased estimator (MVUE).

9. The wireless communication system of claim 6, wherein a storage capacity at the eNB is determined according to a latency of the evolved core network.

10. The wireless communication system of claim 6, wherein the popularities and the sizes of the packets are obtained via the PCRF.

11. A method of processing packets in a wireless communication system comprising an evolved core network, a plurality of user devices, and an evolved node B (eNB), the evolved core network comprising a caching management gateway and a mobile management entity (MME), the method comprising:
sending, via one of the user devices, a request to the eNB;
decrypting, via the eNB, the request; and
retrieving, via the one of the user devices, the packets from the eNB or from the other user devices according to a decision result;
wherein the decision result is generated by the caching management gateway according to popularities and sizes of the packets, a user device number and a connectivity parameter, the user device number is obtained via the MME, and the connectivity parameter is estimated by the caching management gateway.

12. The method of claim 11, wherein the request is sent from the one of the user devices to the eNB via a physical uplink shared channel (PUSCH), the decision result is applied to the packets to determine whether the eNB or at least one of the user devices caches the packets, and the user devices share the cached packets via a device-to-device (D2D) communication.

13. The method of claim 11, wherein the connectivity parameter is a connectivity among the user devices to be estimated by a minimum variance unbiased estimator (MVUE).

14. The method of claim 11, wherein a storage capacity at the eNB is determined according to a latency of the evolved core network.

15. The method of claim 11, wherein the popularities and the sizes of the packets are obtained via a policy and charging rules function (PCRF) of the evolved core network.

16. The method of claim 11, wherein if the eNB determines that the packets are not cached in the eNB or in the user devices, a packet gateway of the evolved core network routes the request to a remote data server for retrieving packets corresponding to the request.

17. A wireless communication system, comprising:
a plurality of user devices;
an evolved node B (eNB), coupled to the plurality of user devices; and
an evolved core network, coupled to the eNB, comprising a caching management gateway and a mobile management entity (MME);
wherein one of the user devices sends a request to the eNB, the eNB decrypts the request, the one of the user devices retrieves the packets corresponding to the request from the eNB or from the other user devices according to a decision result, the decision result is generated by the caching management gateway according popularities and sizes of the packets, an user device number and a connectivity parameter, the user device number is obtained via the MME, and the connectivity parameter is estimated by the caching management gateway.

18. The wireless communication system of claim 17, wherein the request is sent from the one of the user devices to the eNB via a physical uplink shared channel (PUSCH), the decision result is applied to the packets to determine whether the eNB or at least one of the user devices caches the packets, and the user devices share the cached packets via a device-to-device (D2D) communication.

19. The wireless communication system of claim 17, wherein the connectivity parameter is a connectivity among the user devices to be estimated by a minimum variance unbiased estimator (MVUE).

20. The wireless communication system of claim 17, wherein a storage capacity at the eNB is determined according to a latency of the evolved core network.

21. The wireless communication system of claim 17, wherein the popularities and the sizes of the packets are obtained via a policy and charging rules function (PCRF) of the evolved core network.

22. The wireless communication system of claim 17, wherein if the eNB determines that the packets are not cached in the eNB or in the user devices, a packet gateway of the evolved core network routes the request to a remote data server for retrieving packets corresponding to the request.
